(19) United States
(12) Patent Application Publication
(10) Pub. No.: US 2023/0092177 A1
(43) Pub. Date: Mar. 23, 2023

(54) EFFICIENT METHOD FOR MANAGING STORAGE SPACE AND SNAPSHOTS

(71) Applicant: VMware, Inc., Palo Alto, CA (US)

(72) Inventors: Enning XIANG, San Jose, CA (US); Wenguang WANG, Santa Clara, CA (US); Yiqi XU, Mountain View, CA (US); Qinkai FAN, Sunnyvale, CA (US)

(21) Appl. No.: 17/478,397

(22) Filed: Sep. 17, 2021

(51) Int. Cl. G06F 3/06

(52) U.S. Cl. CPC G06F 3/0619; G06F 3/0613; G06F 3/064; G06F 3/0659; G06F 3/0665; G06F 3/067

(57) ABSTRACT

A method of managing storage space of a storage device containing a plurality of snapshots of a file includes the steps of: recording a first count record that includes a number of data blocks that are owned by a first snapshot; after recording the first count record, recording a second count record that includes a number of data blocks that are both owned by the first snapshot and shared with a second snapshot that is a child snapshot of the first snapshot; and determining an amount of reclaimable space of the first snapshot as the difference between the numbers of data blocks of the first and second count records.

### BACKGROUND

In a virtualized computer system, virtual machines (VMs) execute on hosts, and virtual disks of the VMs are provisioned in a storage device accessible to the hosts as files of the computer system. As the VMs issue write input/output operations (IOS) to the virtual disks, the states of the virtual disks change over time. To preserve the state of a virtual disk at any particular point in time, a snapshot of the virtual disk is created. After a snapshot of the virtual disk is created, write IOs issued to data blocks that were allocated to the virtual disk before the creation of the snapshot result in allocations of new data blocks, and data being written into the new data blocks. In this manner, the state of the virtual disk at the time the snapshot was taken is preserved. Over time, a series of snapshots of the virtual disk may be taken, and the state of the virtual disk may be restored to any of the prior states that have been preserved by the snapshots.

As the storage device fills up, snapshots may be targeted for deletion to free up space in the storage device. To select snapshots for deletion, it is useful to know how much storage space can be reclaimed by deleting them. The reclaimable storage space includes data blocks that are accessible to a selected snapshot but that are unshared with either a parent snapshot or child snapshot of the selected snapshot. Accordingly, calculating the reclaimable space of a snapshot can be expensive because it requires scanning not only a data structure corresponding to a selected snapshot, but also data structures corresponding to a parent snapshot and a child snapshot to determine which of the data blocks of the selected snapshot are shared and cannot be deleted. An improvement over this approach, referred to as the “sketch algorithm,” has been proposed for reducing the computational load. The sketch algorithm includes collecting hash codes of sample data blocks, referred to as “fingerprints.” However, significant storage space is required for storing these fingerprints, and a large sample dataset of fingerprints is required for high estimation accuracy.

### SUMMARY

Accordingly, one or more embodiments provide a method of managing storage space of a storage device containing a plurality of snapshots of a file. The method includes the steps of: recording a first count record that includes a number of data blocks that are owned by a first snapshot, after recording the first count record, recording a second count record that includes a number of data blocks that are both owned by the first snapshot and shared with a second snapshot that is a child snapshot of the first snapshot; and determining an amount of reclaimable space of the first snapshot as the difference between the numbers of data blocks of the first and second count records.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computer system in which embodiments may be implemented.

FIG. 2 is a block diagram of a snapshot logical map data structure for a virtual disk, according to embodiments.

FIG. 3 is a block diagram of a snapshot metadata table data structure that stores various values corresponding to node IDs, according to embodiments.

FIG. 4 is a block diagram of a count record map data structure that stores metadata that may be used for calculating the reclaimable space of snapshots, according to embodiments.

FIGS. 5A-5K are a sequence of system diagrams illustrating an example of metadata of shared storage as a snapshot module manages states of a file.

FIG. 6 is a flow diagram of steps carried out by the snapshot module to perform a method of creating a snapshot and updating data structures, according to an embodiment.

FIG. 7 is a flow diagram of steps carried out by a storage controller to perform a method of executing a write IO and updating metadata, according to an embodiment.

FIG. 8 is a flow diagram of steps carried out by a snapshot manager and the storage controller to perform a method of freeing storage space, according to an embodiment.

FIG. 9 is a flow diagram of steps carried out by the snapshot module to perform a method of calculating the amount of reclaimable storage space of a selected snapshot, according to an embodiment.

FIG. 10 is a flow diagram of steps carried out by the storage controller to perform a method of deleting a selected snapshot and updating data structures, according to an embodiment.

FIG. 11 is a flow diagram of steps carried out by the storage controller to perform a method of reverting to a selected snapshot and updating data structures, according to an embodiment.

### DETAILED DESCRIPTION

Techniques for managing storage space of a storage device are described. The techniques involve calculating the reclaimable storage space of snapshots by leveraging various metadata about the snapshots. This metadata includes virtual block addresses, which are monotonically increasing numbers that are assigned to data blocks as new data blocks are allocated to a virtual disk. Based on such virtual block addresses, data blocks of snapshots are organized into segments of a count record map data structure. As new data blocks are allocated to virtual disks and snapshots are created, deleted, and reverted to, the count record map is updated along with other metadata.

Using count records of the count record map, the amount of reclaimable storage space of a snapshot may be quickly determined. Other metadata may then be leveraged to delete the snapshot and free data blocks that are “exclusively owned” by that snapshot. As used herein, data blocks that are “owned” by the snapshot include data blocks that were allocated to the file before the snapshot was created but after its parent snapshot was created. Data blocks that are “exclusively owned” by the snapshot include data blocks of the file that are owned by the snapshot and that are inaccessible to its child snapshot, i.e., unshared with its child snapshot. The techniques described herein require a minimal amount of storage and computational overhead.

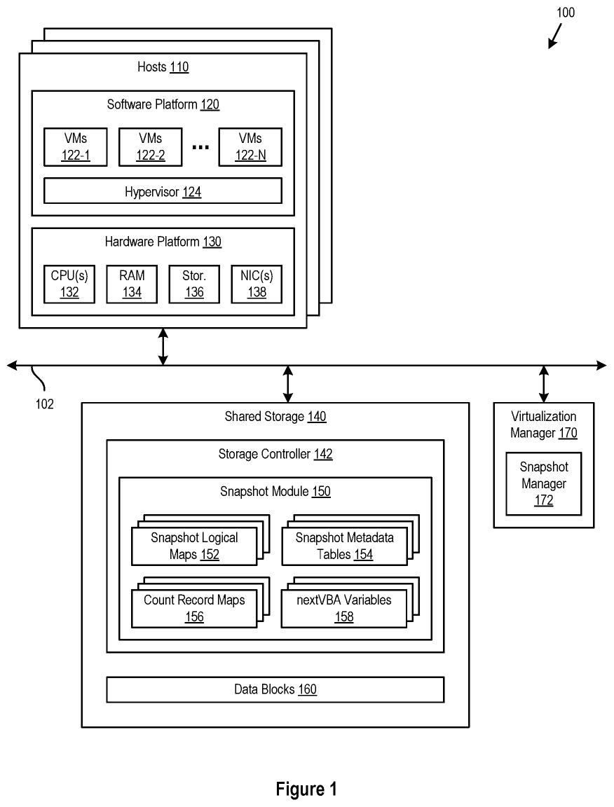

FIG. 1 is a block diagram of a virtualized computer system 100 in which embodiments may be implemented. Virtualized computer system 100 includes a cluster of hosts 110, shared storage 140, and a virtualization manager 170.

Each host 110 is constructed on a server grade hardware platform 130 such as an x86 architecture platform. Hardware platform 130 includes conventional components of a computing device, such as one or more central processing units (CPUs) 132, system memory 134 such as random-access memory (RAM), optional local storage 136 such as one or more hard disk drives (HDDs) or solid-state drives (SSDs), and one or more network interface cards (NICs) 138. CPU(s) 132 are configured to execute instructions such as executable instructions that perform one or more operations described herein, which may be stored in system memory 134. NIC(s) 138 enable hosts 110 to communicate with each other and with other devices over a physical network 102.

Each hardware platform 130 supports a software platform 120. Software platform 120 includes a hypervisor 124, which is a virtualization software layer that abstracts hardware resources of hardware platform 130 for concurrently running VMs 122. One example of a hypervisor 124 that may be used is a VMware ESX® hypervisor by VMware, Inc. Although the disclosure is described with reference to VMs 122, the teachings herein also apply to other types of virtual computing instances such as containers, Docker® containers, data compute nodes, isolated user space instances, and the like.

Shared storage 140 is a storage device that stores data blocks 160 of files for hosts 110, including files that are virtual disks of VMs 122. Shared storage 140 includes a storage controller 142 for handling IOs issued to the virtual disks by VMs 122. Storage controller 142 includes a snapshot module 150 for creating snapshots and managing snapshot logical map data structures 152, snapshot metadata table data structures 154, count record map data structures 156, and nextVBA variables 158, which will all be discussed further below.

According to embodiments, when a virtual disk is created, the virtual disk is initially empty. After data blocks 160 have been allocated to the virtual disk, a snapshot of the virtual disk may be created. The snapshot includes metadata such as pointers to allocated data blocks 160. Later, as more data blocks 160 are allocated to the virtual disk and more snapshots are created, each successive snapshot includes pointers to data blocks 160 of the virtual disk that have been newly allocated since the last snapshot of the virtual disk was created. As a way to track such new data blocks 160, snapshot module 150 establishes a “running point” of the virtual disk when the virtual disk is created and re-establishes the running point of the virtual disk each time a snapshot of the virtual disk is created. Metadata of the running point contains pointers to data blocks 160 that have been allocated since the establishment of the “running point.” In other embodiments, such as when a VM is cloned, the metadata of the virtual disk of the VM clone contains pointers to a “base image.” In such embodiments, when a first snapshot is created, the first snapshot becomes a child snapshot of the base image.

In the embodiment depicted in FIG. 1, shared storage 140 is, e.g., network-attached storage (NAS) that is accessible to each host 110 through a corresponding NIC 138. However, shared storage 140 may also be a storage array that each host 110 accesses by using a host bus adapter (HBA) (not shown) to communicate over a fibre channel (not shown). Shared storage 140 may also be a virtual storage area network (vSAN) device that is aggregated and provisioned from local storage 136 of hosts 110.

Virtualization manager 170 communicates with hosts 110 via a management network (not shown) to perform administrative tasks such as managing hosts 110, provisioning and managing VMs 122, migrating VMs 122 between hosts 110, and load balancing between hosts 110. Virtualization manager 170 may be a VM 122 executing in one of hosts 110 or a computer program that resides and executes in a separate server. One example of a virtualization manager 170 is the VMware vCenter Server® by VMware, Inc. Virtualization manager 170 includes a snapshot manager 172 for generating instructions such as to create, delete, or revert to snapshots of shared storage 140. Snapshot manager 172 transmits such instructions to snapshot module 150 via physical network 102.

Although FIG. 1 illustrates hosts 110 accessing a shared storage 140, each host 110 may instead separately store its own snapshots and running points of virtual disks in local storage 136. Accordingly, each hypervisor 124 may include its own separate snapshot module 150. Additionally, although FIG. 1 illustrates a virtualized computer system 100, other embodiments include nonvirtualized computer systems in which snapshots and running points are managed for files.

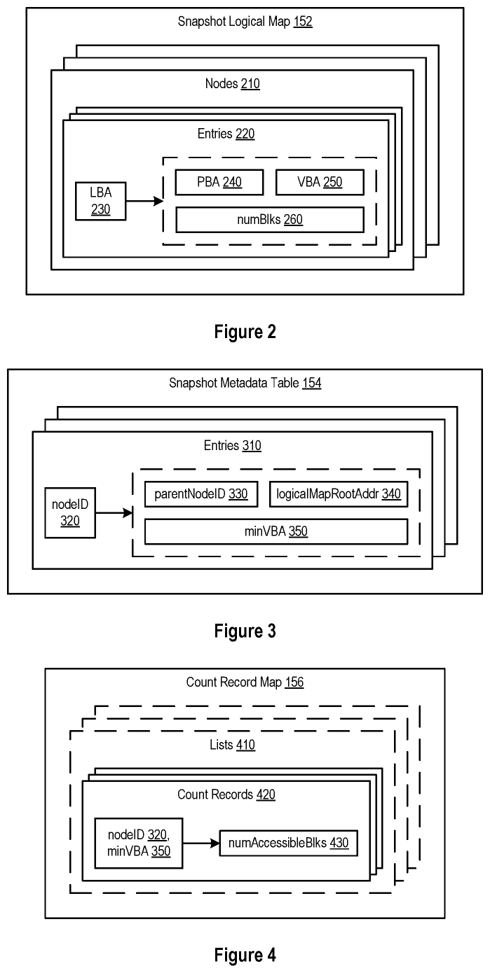

FIG. 2 is a block diagram of a snapshot logical map 152 for a virtual disk, according to embodiments. Snapshot logical map 152 is a data structure such as a copy-on-write B+ tree that includes a plurality of nodes 210. Anode 210 may be anode fora snapshot or a node for the running point. In other embodiments, snapshot module 150 maintains a separate data structure such as a B+ tree for each of the snapshots and the running point.

Each node 210 is uniquely identified by a node ID and contains one or more entries 220, the key of each entry 220 being a logical block address (LBA) 230 of the first data block in a block extent (which is a group of contiguous data blocks). The value of each entry 220 includes a physical block address (PBA) 240 corresponding to LBA 230, a virtual block address (VBA) 250 corresponding to LBA 230, and a number of data blocks (numBlks) 260 in the sequential range starting from LBA 230. A PBA 240 is a physical block address of shared storage 140. VBAs 250 are monotonically increasing numbers that are assigned to data blocks 160 as data blocks 160 are newly allocated to the virtual disk.

FIG. 3 is a block diagram of a snapshot metadata table 154 for a virtual disk, according to embodiments. Snapshot metadata table 154 contains a plurality of entries 310. There is one entry 310 for each snapshot and one entry 310 for the running point. The key of each entry 310 is a node ID (“nodeID”) 320 of the corresponding snapshot or running point. The value of each entry 310 includes a parent node ID (“parentNodeID”) 330, a logical map root address (“logicalMapRootAddr”) 340, and a minimum VBA (“minVBA”) 350.

ParentNodeID 330 stores node ID 320 of the parent of the snapshot/running point. In the embodiments described herein, the snapshot that is created to trigger the establishment of the running point is the parent of the running point. LogicalMapRootAddr 340 stores PBA 240 at which the root node of snapshot logical map 152 is stored, i.e., PBA 240 of node 210 of the first snapshot created. All data blocks 160 of a snapshot/running point are referred to herein as a “segment” of data blocks 160. MinVBA 350 is the lowest VBA 250 assigned to a segment. Because VBAs 250 are monotonically increasing numbers, minVBA 350 of a snapshot is always greater than that of its parent.

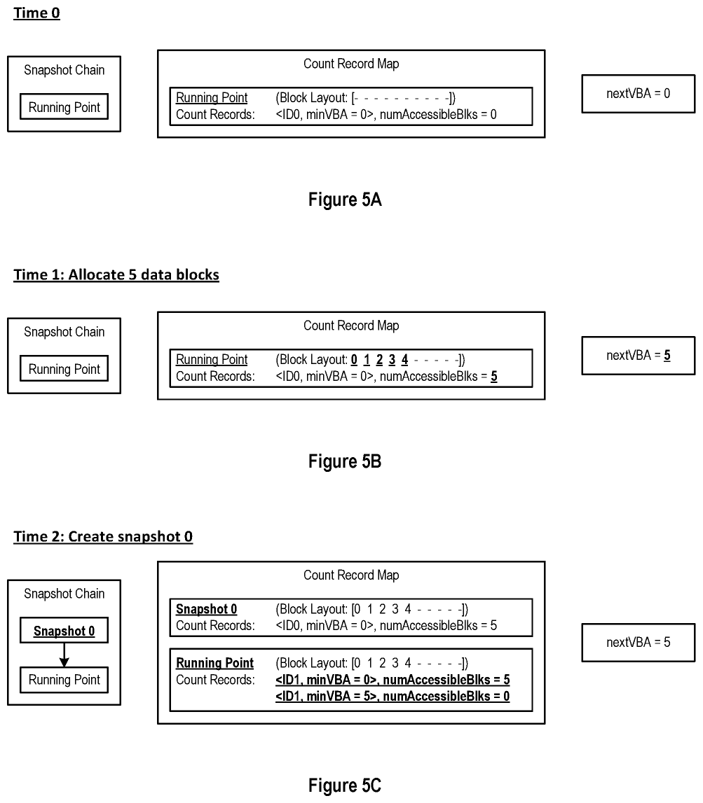

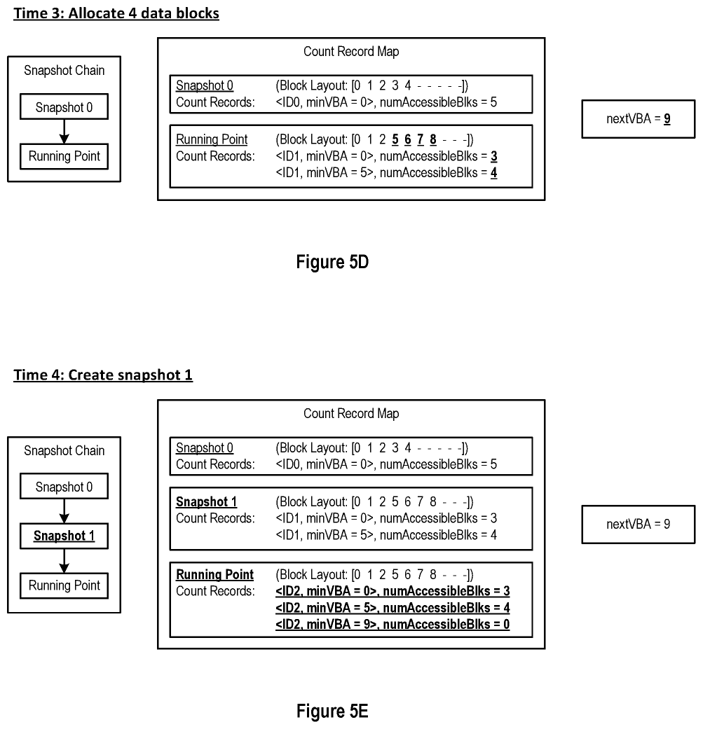

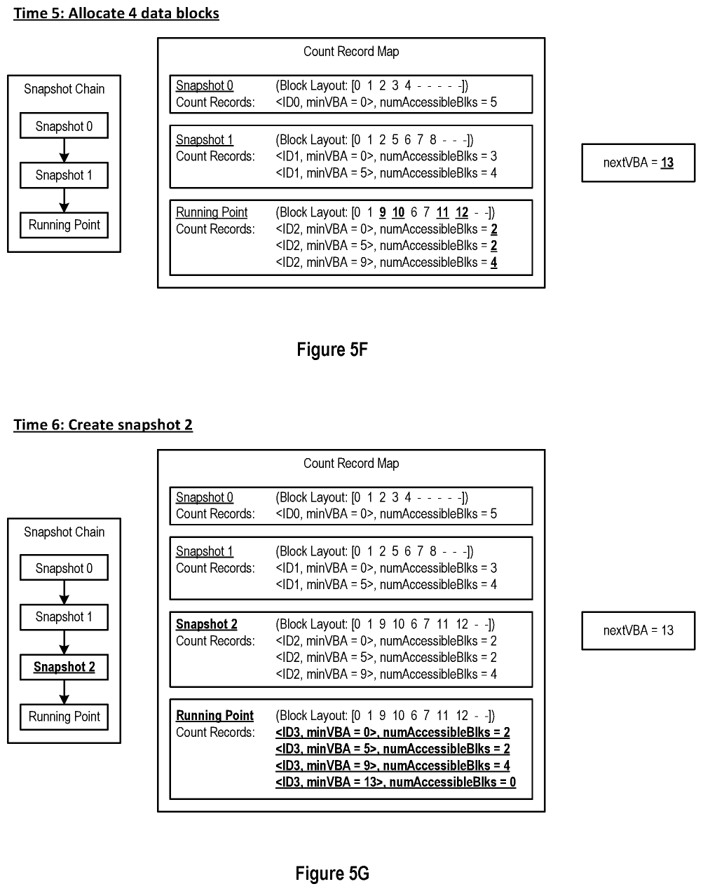

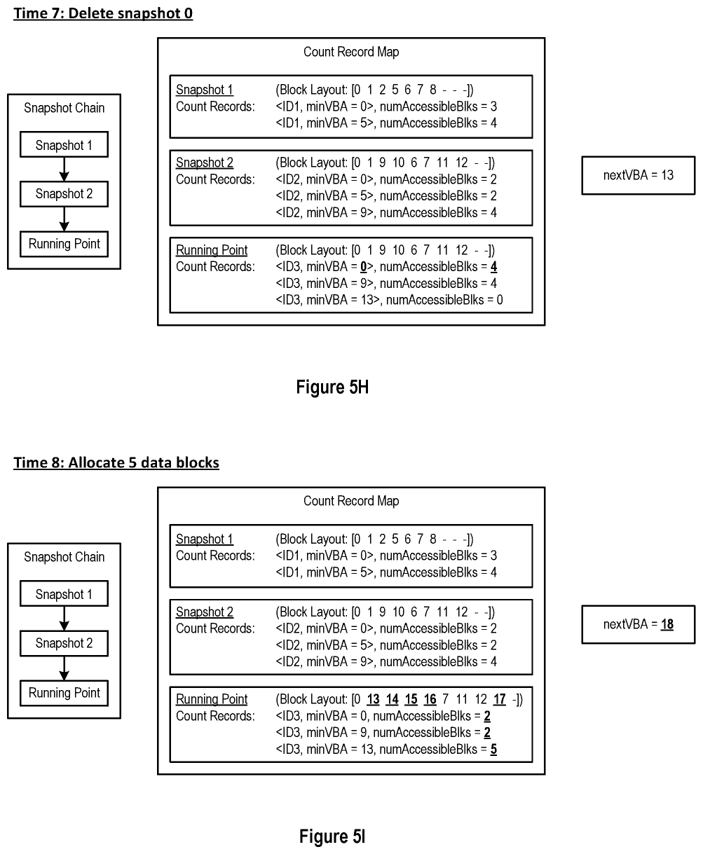

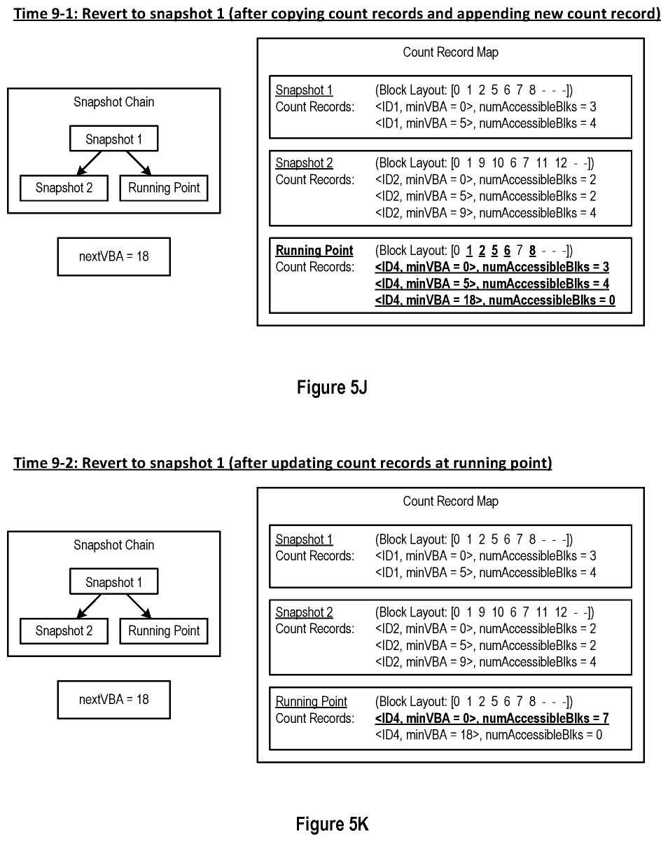

FIG. 4 is a block diagram of a count record map 156, according to embodiments. Count record map 156 is a data structure such as a B-+ tree that includes count records 420. Count records 420 are logically grouped into lists 410 by nodeID 320. Since nodeID 320 identifies a particular snapshot or the running point, each of lists 410 belong to a particular snapshot or the running point. Within a snapshot's/running point's list 410, each count record 420 further corresponds to a segment of data blocks 160 that are owned by the running point or one of the snapshots. Specifically, the key of each count record 420 includes two items. The first item is nodeID 320 of the snapshot/running point corresponding to list 410, and the second item is minVBA 350 of a segment of data blocks 160. The value of each count record 420 stores the number of data blocks 160 of the segment that are accessible to the snapshot/running point corresponding to list 410 (as “numAccessibleBlks” 430). The mechanics of updating count record map 156 as data blocks 160 are allocated and snapshots are created, deleted, and reverted to are exemplified in FIGS. 5A-5K.

The storage overhead of a count record map 156 is minimal. For example, each count record 420 may be stored as 13 bytes of data as follows: 4 bytes for nodeID 320, 5 bytes for minVBA 350, and 4 bytes for numAccessibleBlks 430. As such, if each data block 160 has a capacity of 4 KB, each data block 160 can store 314 count records 420. The storage space required for storing count records 420 is thus relatively low. Furthermore, the computational overhead of reading and updating count records 420 is relatively low. Because count records 420 of a list 410 may be stored contiguously within the same data block 160, a single access to a count record 420 may be accompanied by caching all count records 420 of list 410 for quick accesses. As such, embodiments for managing storage space may utilize such count records 420 with minimal storage and computational overhead and use such count records 420 for calculating the reclaimable storage space of snapshots, as discussed further below.

FIG. 5A is an exemplary system diagram illustrating metadata of shared storage 140 after a virtual disk is created. Time 0 illustrates a “snapshot chain” (left), count record map 156 (middle), and nextVBA variable 158 (right). Generally, a snapshot chain includes the snapshots and running point of a virtual disk. At time 0, as shown in the snapshot chain, there is only a running point and not yet any snapshots.

Count record map 156 includes a single list 410 of the running point. The “block layout” of the running point's list 410 represents up to 10 data blocks 160 that are accessible to the running point. The block layout is used throughout FIGS. 5A-5K to illustrate how data blocks 160 of the virtual disk become accessible or inaccessible over time. The block layout is illustrated for clarity and is not physically included in count record map 156. At time 0, the block layout is empty.

Because there are no snapshots in the snapshot chain, the running point's list 410 only includes a single count record 420 that corresponds to the running point's segment of data blocks 160. The key of count record 420 includes a nodeID 320 of “ID0,” which is assigned to the running point. At time 0, no data blocks 160 have been allocated to the virtual disk. As such, the running point contains no data blocks 160, and no VBAs 250 have been assigned. The first VBA 250 assigned to a running point data block 160 will be 0, and each subsequent VBA 250 will be a number greater than 0. The key of count record 420 thus includes a minVBA 350 of 0. Furthermore, because no data blocks 160 have been added to the running point, numAccessibleBlks 430 is also set to 0. NextVBA 158 stores VBA 250 that will be assigned to the next data block 160 allocated to the virtual disk, which again is 0.

FIG. 5B is an exemplary system diagram after data blocks 160 are allocated to the virtual disk. At time 1, VM 122 issues a write IO, and in response, storage controller 142 allocates 5 data blocks 160 to the virtual disk. Snapshot module 150 assigns VBAs 250 of 0-4 to data blocks 160 and adds them to the running point. As shown in the block layout, the running point now has access to the 5 data blocks 160. Snapshot module 150 updates numAccessibleBlks 430 from 0 to 5 because 5 data blocks 160 of the running point's segment can be accessed now. Finally, snapshot module 150 updates nextVBA 158 from 0 to 5 because the next VBA 250 that will be assigned is 5.

FIG. 5C is an exemplary system diagram after a snapshot is created. At time 2, snapshot manager 172 transmits an instruction to snapshot module 150 to create a snapshot. In the snapshot chain, a snapshot 0 is created from the old running point. A new running point is created, which becomes the child of snapshot 0.

In count record map 156, snapshot module 150 first makes copies of each count record 420 of the old running point's list 410. Snapshot module 150 thus copies count record 420 with a <nodeID 320, minVBA 350> pair of <ID0, 0>, that count record 420 now corresponding to snapshot 0. For the copy in the new running point's list 410, snapshot module 150 uses a nodeID 320 of “ID1,” which corresponds to the new running point.

Finally, snapshot module 150 adds a new count record 420 to the new running point's list 410, again with a nodeID 320 of “ID1.” Because nextVBA 158 is currently set to 5, minVBA 350 of the new running point's segment is set to 5. Because no data blocks 160 have been added to the new running point's segment, numAccessibleBlks 430 is set to 0.

FIG. 5D is an exemplary system diagram after more data blocks 160 are allocated to the virtual disk. At time 3, VM 122 issues a write IO, and in response, storage controller 142 allocates 4 data blocks 160 to the virtual disk. Snapshot module 150 assigns VBAs 250 of 5-8 to data blocks 160 and adds them to the running point. As shown in the block layout of the running point's list 410, data blocks 160 with VBAs 250 of 5-8 can be accessed now. Furthermore, the write IO included instructions to overwrite data blocks 160 with VBAs 250 of 3 and 4. As such, storage controller 142 allocated data blocks 160 with VBAs 250 of 5 and 6 and left data blocks 160 with VBAs 250 of 3 and 4 intact. However, data blocks 160 with VBAs 250 of 3 and 4 are now inaccessible (unless snapshot 0 is reverted to).

Count record 420 of snapshot 0's list 410 has not been changed. Lists 410 of snapshots are immutable. In the first count record 420 of the running point's list 410, which corresponds to snapshot 0's segment, numAccessibleBlks 430 is updated from 5 to 3. This is because there are now only 3 data blocks 160 from that segment that are accessible: those with VBAs 250 of 0-2. In the second count record 420, which corresponds to the running point's segment, numAccessibleBlks 430 is updated from 0 to 4 because there are now 4 data blocks 160 from that segment that are accessible: those with VBAs 250 of 5-8. Finally, snapshot module 150 updates nextVBA 158 from 5 to 9 because the next VBA 250 that will be assigned is 9.

FIG. 5E is an exemplary system diagram after another snapshot is created. At time 4, snapshot manager 172 transmits an instruction to snapshot module 150 to create a snapshot. In the snapshot chain, snapshot 1 is created from the old running point, the parent of snapshot 1 being snapshot 0. A new running point is created, which becomes the child of snapshot 1.

In count record map 156, snapshot module 150 first makes copies of each count record 420 of the old running point's list 410, count records 420 with nodeIDs 320 of ID1 now corresponding to snapshot 1. For the copies in the new running point's list 410, snapshot module 150 uses a nodeID 320 of “ID2,” which corresponds to the new running point. Finally, snapshot module 150 adds a new count record 420 to the new running point's list 410, again with a nodeID 320 of ID2. Because nextVBA 158 is currently set to 9, minVBA 350 of the new running point's segment is set to 9. Because no data blocks 160 have been added to the new running point's segment, numAccessibleBlks 430 is set to 0.

FIG. 5F is an exemplary system diagram after more data blocks 160 are allocated to the virtual disk. At time 5, VM 122 issues a write IO, and in response, storage controller 142 allocates 4 data blocks 160 to the virtual disk. Snapshot module 150 assigns VBAs 250 of 9-12 to data blocks 160 and adds them to the running point. As shown in the block layout of the running point's list 410, data blocks 160 with VBAs 250 of 9-12 can be accessed now. Furthermore, the write IO included instructions to overwrite data blocks 160 with VBAs 250 of 2, 5, and 8.

In the first count record 420 of the running point's list 410, which corresponds to snapshot 0's segment, numAccessibleBlks 430 is updated from 3 to 2 because only 2 data blocks 160 from that segment that are now accessible: those with VBAs 250 of 0 and 1. In the second count record 420, which corresponds to snapshot 1's segment, numAccessibleBlks 430 is updated from 4 to 2 because only 2 data blocks 160 from that segment are now accessible: those with VBAs 250 of 6 and 7. In the last count record 420, which corresponds to the running point's segment, numAccessibleBlks 430 is updated from 0 to 4 because 4 data blocks 160 from that segment are now accessible: those with VBAs 250 of 9-12. Finally, snapshot module 150 updates nextVBA 158 from 9 to 13.

FIG. 5G is an exemplary system diagram after another snapshot is created. At time 6, snapshot manager 172 transmits an instruction to snapshot module 150 to create a snapshot. In the snapshot chain, snapshot 2 is created from the old running point, the parent of snapshot 2 being snapshot 1. A new running point is created, which becomes the child of snapshot 2.

In count record map 156, snapshot module 150 first makes copies of each count record 420 of the old running point's list 410, count records 420 with nodeIDs 320 of ID2 now corresponding to snapshot 2. For the copies in the new running point's list 410, snapshot module 150 uses a nodeID 320 of “ID3,” which corresponds to the new running point. Finally, snapshot module 150 adds a new count record 420 to the new running point's list 410, again with a nodeID 320 of “ID3.” Because nextVBA 158 is currently set to 13, minVBA 350 of the new running point's segment is set to 13. Because no data blocks 160 have been added to the new running point's segment, numAccessibleBlks 430 is set to 0.

Before moving on to the deletion of a snapshot in FIG. 5H, an example of calculating the number of reclaimable data blocks 160 of such a snapshot will be discussed with reference to FIG. 5G. If snapshot manager 172 transmits an instruction to snapshot module 150 to free storage space, snapshot module 150 may select a snapshot for deletion. For example, snapshot module 150 may select the oldest snapshot in the snapshot chain, which is snapshot 0. According to embodiments, when a snapshot is deleted, any data blocks 160 of its segment that are shared with its child are inherited by its child. Only those data blocks 160 that were exclusively accessible to the deleted snapshot may be freed.

Accordingly, to determine the amount of reclaimable data blocks 160, snapshot module 150 considers two variables: (1) the total amount of data blocks 160 of the segment of the snapshot selected for deletion and (2) the amount of such data blocks 160 that are accessible to its child. The second variable is subtracted from the first variable to determine the total amount of reclaimable data blocks 160. Determining the reclaimable storage space according to embodiments thus merely requires performing a single subtraction operation, which is a relatively small amount of computational overhead.

In FIG. 5G, the total amount of data blocks 160 of snapshot 0's segment may be determined by referencing snapshot 0's list 410. Within this list 410, numAccessibleBlks 430 of count record 420 corresponding to snapshot 0's segment (the only count record 420 of list 410 in this case) is 5. The amount of such data blocks 160 that are accessible to the child may be determined by referencing snapshot 1's list 410. Within this list 410, numAccessibleBlks 430 of count record 420 corresponding to snapshot 0's segment (with a key of <ID1, 0>) is 3. As such, snapshot module 150 may subtract 3 from 5 to determine that 2 data blocks 160 are reclaimable if snapshot 0 is deleted. As illustrated by the block layouts at lists 410 of snapshots 0 and 1, the 2 reclaimable data blocks 160 are those with VBAs 250 of 3 and 4, which are not shared with snapshot 1.

FIG. 5H is an exemplary system diagram after a snapshot is deleted. At time 7, snapshot manager 172 transmits an instruction to snapshot module 150 to delete snapshot 0. In the snapshot chain, snapshot 0 is deleted, and snapshot 1 is updated from having snapshot 0 as a parent snapshot to no longer having a parent.

In count record map 156, snapshot module 150 deletes snapshot 0's list 410 by deleting each count record 420 with a nodeID 320 of ID0. This impacts other count records 420 of count record map 156 because count records 420 of the deleted snapshot 0 must now be merged with count records 420 of its former child, snapshot 1. As previously stated, lists 410 of snapshots of count record map 156 are immutable. As such, snapshot module 150 only updates count records 420 of the running point's list 410. Although lists 410 of snapshots 1 and 2 include stale count records 420, snapshot module 150 does not update such stale count records 420 to avoid excessive computational overhead. If necessary, count records 420 of lists 410 of snapshots 1 or 2 may be correctly interpreted later, e.g., to revert to snapshot 1 or to compute reclaimable storage space, as discussed further below.

Referring back to FIG. 5G, from the running point's list 410, snapshot module 150 selects count records 420 corresponding to the snapshot being deleted (snapshot 0) and its former child (snapshot 1). These are the first two count records 420. When these two count records 420 are merged, the lower minVBA 350 (0) will be used as minVBA 350 of the merged count record 420, and numAccessibleBlks 430 of the merged count record 420 will be the sum of numAccessibleBlks 430 of the two count records 420 (2 data blocks+2 data blocks=4 total data blocks).

Referring back to FIG. 5H, for count record 420 with a key of <ID3, 5>, which corresponds to snapshot 1, minVBA 350 is updated from 5 to 0, and numAccessibleBlks 430 is updated from 2 to 4 Then, the other count record 420 with a key of <ID3, 0>, which corresponds to snapshot 0, is deleted. As such, at the running point's list 410, count records 420 corresponding to snapshots 0 and 1 have been merged into a single count record 420 corresponding to snapshot 1. The merged count record 420 includes data blocks 160 with VBAs 250 from 0 to 8.

FIG. 5I is an exemplary system diagram after more data blocks 160 are allocated to the virtual disk. At time 8, VM 122 issues a write IO, and in response, storage controller 142 allocates 5 data blocks 160 to the virtual disk. Snapshot module 150 assigns VBAs 250 of 13-17 to data blocks 160 and adds them to the running point. As shown in the block layout of the running point's list 410, data blocks 160 with VBAs 250 of 13-17 can be accessed now. Furthermore, the write IO included instructions to overwrite data blocks 160 with VBAs 250 of 1, 6, and 9-10.

In the first count record 420 of the running point's list 410, which corresponds to snapshot 1's segment, numAccessibleBlks 430 is updated from 4 to 2 because only 2 data blocks 160 from that segment that are now accessible: those with VBAs 250 of 0 and 7 In the second count record 420, which corresponds to snapshot 2's segment, numAccessibleBlks 430 is updated from 4 to 2 because only 2 data blocks 160 from that segment are now accessible: those with VBAs 250 of 11 and 12. In the last count record 420, which corresponds to the running point's segment, numAccessibleBlks 430 is updated from 0 to 5 because 5 data blocks 160 from that segment are now accessible: those with VBAs 250 of 13-17. Finally, snapshot module 150 updates nextVBA 158 from 13 to 18.

FIG. 5J is an exemplary system diagram after a snapshot is reverted to. At time 9-1, snapshot manager 172 transmits an instruction to snapshot module 150 to revert to snapshot 1. In the snapshot chain, a new running point is created, the parent of which is snapshot 1. Snapshot 1 thus has two children. Snapshot module 150 deletes the old running point, including freeing any of data blocks 160 in its segment.

In count record map 156, snapshot module 150 first deletes the old running point's list 410 by deleting each count record 420 with a nodeID 320 of ID3. Next, snapshot module 150 makes copies of each count record 420 of snapshot 1's list 410. For the copies in the new running point's list 410, snapshot module 150 uses a nodeID 320 of “ID4,” which corresponds to the new running point. Finally, snapshot module 150 adds a new count record 420 to the new running point's list 410, again with a nodeID 320 of “ID4.” Because nextVBA 158 is currently set to 18, minVBA 350 of the new running point's segment is set to 18. Because no data blocks 160 have been added to the new running point, numAccessibleBlks 430 is set to 0.

FIG. 5K is an exemplary system diagram after updating count records 420 of the running point's list 410. At time 9-2, snapshot module 150 determines that the running point's list 410 includes stale count records 420. For example, snapshot module 150 may check minVBA 350 from each count record 420. Snapshot module 150 may thus find count record 420 with a key of <ID4, 5>, there being no snapshot in the snapshot chain with a minVBA 350 of 5. Given this inconsistency, snapshot module 150 may determine that this count record 420 is stale and must correspond to a snapshot whose minVBA 350 was updated in response to a deletion (snapshot 1).

At the running point's list 410, snapshot module 150 merges count records 420 corresponding to the deleted snapshot 0 with a key of <ID4, 0> with count record 420 corresponding to snapshot 1 with a key of <ID4, 5>. MinVBA 350 of the merged count record 420 is the lower of each minVBA 350 (0), and numAccessibleBlks 430 of the merged count record 420 is the sum of each numAccessibleBlks 430 (3 data blocks+4 data blocks=7 total data blocks). The merged count record 420 includes data blocks 160 with VBAs 250 from 0 to 12, (not data blocks 160 with VBAs 250 of 13-17, which were freed).

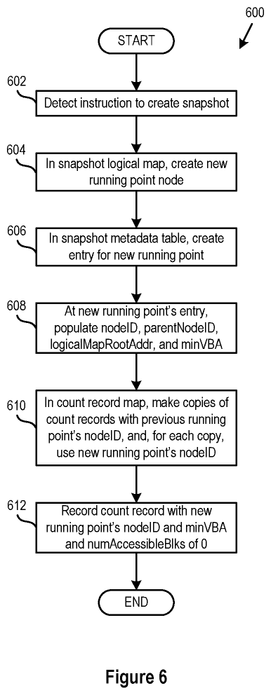

FIG. 6 is a flow diagram of steps carried out by snapshot module 150 to perform a method 600 of creating a snapshot and updating data structures, according to an embodiment. At step 602, snapshot module 150 detects an instruction from snapshot manager 172 to create a snapshot for a particular snapshot chain. Snapshot manager 172 may automatically transmit the instruction after a predetermined time period since a previous snapshot was created. An administrator may also manually instruct snapshot manager 172 to transmit the instruction.

At step 604, in snapshot logical map 152, snapshot module 150 creates a new running point node 210. Turning to snapshot metadata table 154, at step 606, snapshot module 150 creates an entry 310 for the new running point. At step 608, snapshot module 150 populates the fields of entry 310. Snapshot module 150 assigns a nodeID 320 to the new running point and stores it as the key of entry 310. Snapshot module 150 sets parentNodeID 330 to the previous running point's nodeID 320, the previous running point becoming the requested snapshot. Snapshot module 150 sets logicalMapRootAddr 340 to PBA 240 at which the root node 210 of snapshot logical map 152 is stored. Finally, snapshot module 150 sets minVBA 350 as the current value of nextVBA 158.

Turning to count record map 156, at step 610, snapshot module 150 makes copies of count records 420 from list 410 of the new snapshot (the previous running point). For the copies, snapshot module 150 uses nodeID 320 assigned to the new running point. At step 612, snapshot module 150 records a new count record 420 in the new running point's list 410. The key of the new count record 420 includes the new running point's nodeID 320 and minVBA 350. The new running point's minVBA 350 may be determined from snapshot metadata table 154 by using nodeID 320 as a key. MinVBA 350 may also be determined by referencing nextVBA 158. Snapshot module 150 sets numAccessibleBlks 430 to 0. After step 612, method 600 ends.

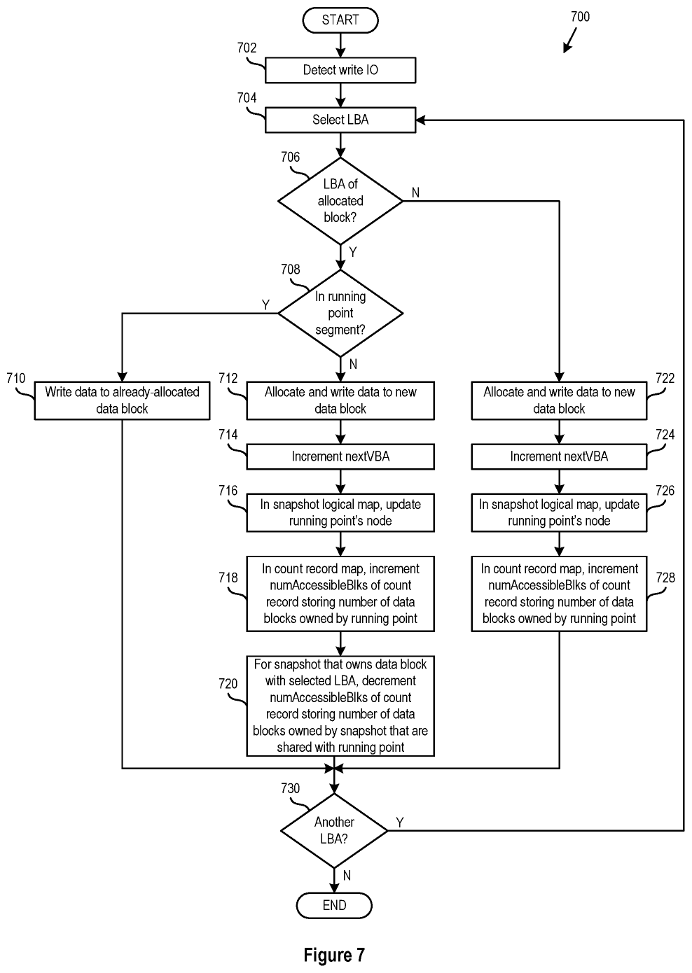

FIG. 7 is a flow diagram of steps carried out by storage controller 142 to perform a method 700 of executing a write IO and updating metadata, according to an embodiment. At step 702, storage controller 142 detects a write IO issued by a VM 122 including one or more LBAs 230 to write to. At step 704, storage controller 142 selects an LBA 230. Snapshot module 150 then determines how to execute the write IO for data block 160 with the selected LBA 230 based whether the write is to: (1) an already-allocated data block 160 of the running point; (2) an already-allocated data block 160 of a snapshot; or (3) a new data block 160.

At step 706, snapshot module 150 checks if the selected LBA 230 is to an already-allocated data block 160 by scanning entries 220 of snapshot logical map 152 for the selected LBA 230. The selected LBA 230 may be the key of an entry 220 or may correspond to a data block 160 within the block extent of an entry 220. If snapshot module 150 finds the selected LBA 230, the write IO is to an already-allocated data block 160, and method 700 moves to step 708.

At step 708, snapshot module 150 determines if the already-allocated data block 160 is part of the running point's segment. Data block 160 is part of the running point's segment if LBA 230 was found at the running point's node 210. If data block 160 is part of the running point's segment, method 700 moves to step 710, and storage controller 142 writes directly to data block 160. Specifically, storage controller 142 locates PBA 240 of data block 160 in snapshot logical map 152 and executes the write IO at the located PBA 240.

Referring back to step 708, if data block 160 is not part of the running point's segment, method 700 moves to step 712. At step 712, because data block 160 is part of a snapshot, storage controller 142 does not write directly to data block 160. Instead, storage controller 142 allocates a new data block 160 with a new LBA 230. Snapshot module 150 assigns a VBA 250 to the newly allocated data block 160, the VBA 250 being the value of nextVBA 158. Storage controller 142 then writes to the new data block 160. At step 714, snapshot module 150 increments nextVBA 158.

At step 716, snapshot module 150 either adds an entry 220 to the running point's node 210 or updates an existing entry 220. In the case of a new data block 160 that is not contiguous with any entries 220, snapshot module 150 creates a new entry 220 with the selected LBA 230. Snapshot module 150 then stores the corresponding PBA 240 and VBA 250 of the new data block 160 and sets numBlks 260 to 1. On the other hand, in the case of contiguous data blocks 160, snapshot module 150 merely increments numBlks 260 of an entry 220 to encompass the new data block 160.

Turning to count record map 156, at step 718, from the running point's list 410, snapshot module 150 increments numAccessibleBlks 430 of count record 420 storing the number of data blocks 160 owned by the running point. Snapshot module 150 accesses this count record 420 by using the running point's nodeID 320 to find the corresponding minVBA 350 in snapshot metadata table 154 and then using nodeID 320 and minVBA 350 as a key in count record map 156. At step 720, for the snapshot that owns data block 160 with LBA 230 selected at step 704, snapshot module 150 decrements numAccessibleBlks 430 of count record 420 storing the number of data blocks 160 owned by the snapshot that are shared with the running point. Specifically, snapshot module 150 locates VBA 250 of the now-inaccessible data block 160 in snapshot logical map 152 and updates count record 420 in the running point's list with the greatest minVBA 350 that is less than or equal to the located VBA 250.

Referring back to step 706, if snapshot module 150 could not find the selected LBA 230 in snapshot logical map 152, LBA 230 does not correspond to an already-allocated data block 160, and method 700 moves to step 722. Snapshot module 150 performs steps 722-728 similarly to steps 712-718. In count record map 156, snapshot module 150 does not decrement numAccessibleBlks 430 for any count records 420 because no data blocks 160 have been made inaccessible to the running point. At step 730, if there is another LBA 230 to write to, method 700 returns to step 704, and storage controller 142 selects another LBA 230. Otherwise, the execution of the write IO is complete, and method 700 ends.

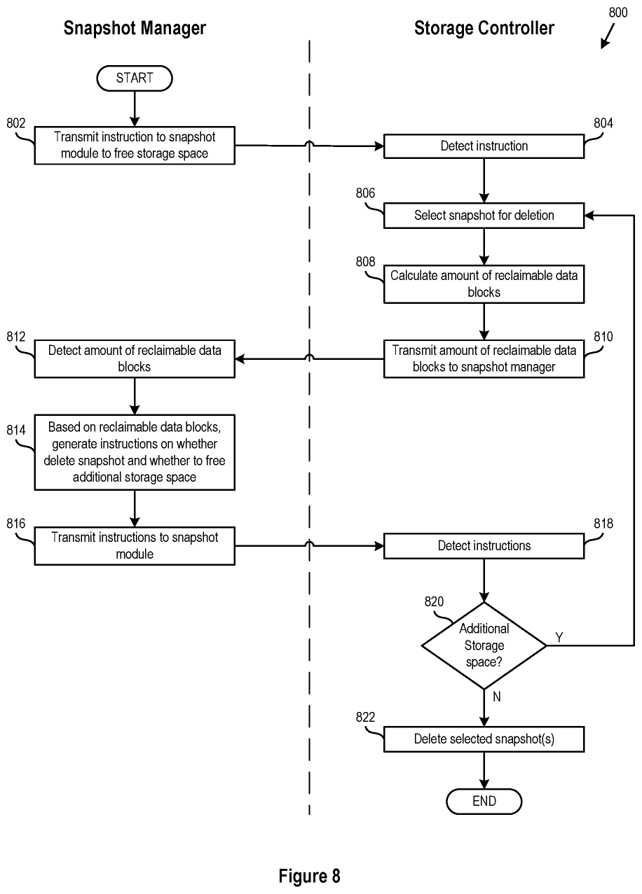

FIG. 8 is a flow diagram of steps carried out by snapshot manager 172 and storage controller 142 to perform a method 800 of freeing storage space, according to an embodiment. At step 802, snapshot manager 172 transmits an instruction to snapshot module 150 of storage controller 142 to free storage space. For example, snapshot manager 172 may automatically generate the instruction in response to detecting that the amount of free storage space of shared storage 140 has fallen below a threshold. An administrator may also manually instruct snapshot manager 172 to generate the instruction.

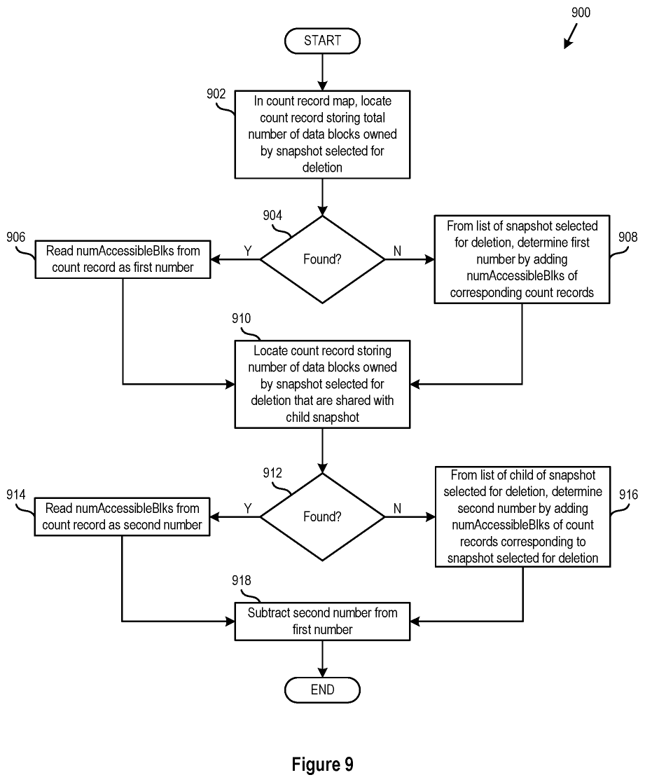

At step 804, snapshot module 150 detects the instruction to free storage space. At step 806, snapshot module 150 selects a snapshot for deletion. For example, snapshot module 150 may select the oldest snapshot of a particular snapshot chain. At step 808, snapshot module 150 calculates the amount of reclaimable data blocks 160 if the selected snapshot is deleted. Such a calculation is discussed further below in conjunction with FIG. 9. At step 810, snapshot module 150 transmits the amount of reclaimable data blocks 160 to snapshot manager 172. At step 812, snapshot manager 172 detects the amount of reclaimable data blocks 160.

At step 814, based on the amount of reclaimable data blocks 160, snapshot manager 172 generates instructions on whether to delete the snapshot selected at step 806 and whether to free additional storage space. For example, if the amount is sufficiently large to create a threshold amount of free storage space, snapshot manager 172 determines to delete the selected snapshot. If not, snapshot manager 172 may determine not to delete the selected snapshot at all, or to delete the selected snapshot and to delete one or more additional snapshots. An administrator may also manually instruct snapshot manager 172 on such determinations.

At step 816, snapshot manager 172 transmits the instructions generated at step 814 to snapshot module 150. At step 818, snapshot module 150 detects the instructions. At step 820, if snapshot module 150 is instructed to free additional storage space, method 800 returns to step 806, and snapshot module 150 selects another snapshot for deletion, e.g., the next oldest snapshot. Otherwise, if snapshot module 150 is not instructed to free additional storage space, method 800 moves to step 822.

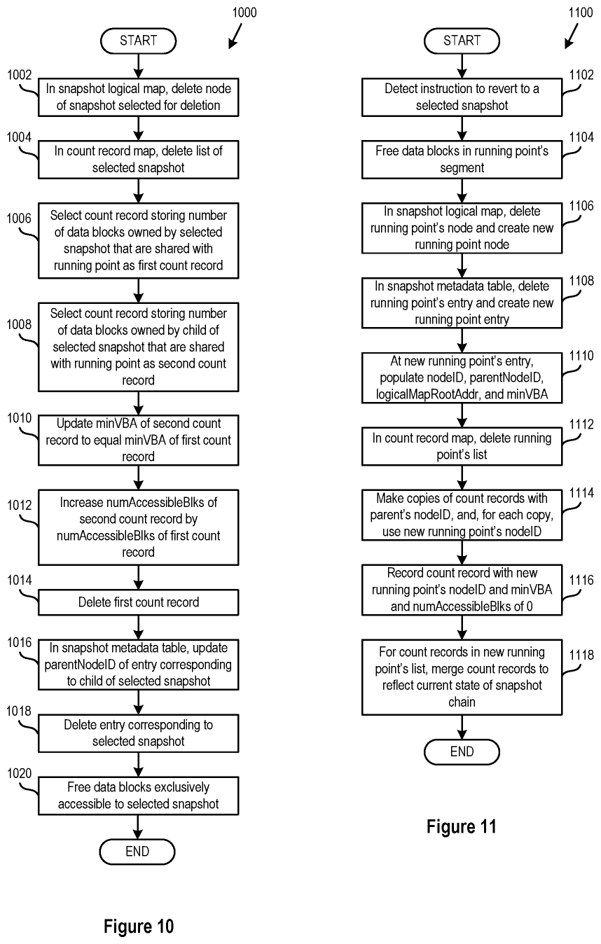

At step 822, storage controller 142 deletes each snapshot that has been selected for deletion. Storage controller 142 thus frees the reclaimable storage blocks 160 of each selected snapshot, and snapshot controller 150 updates snapshot logical map 152, snapshot metadata table 154, and count record map 156 accordingly. The deletion of snapshots is discussed further below in conjunction with FIG. 10. After step 822, method 800 ends.

FIG. 9 is a flow diagram of steps carried out by snapshot module 150 to perform a method 900 of calculating the amount of reclaimable storage space of a selected snapshot, according to an embodiment. At step 902, snapshot module 150 attempts to locate a count record 420 storing the total number of data blocks 160 owned by the snapshot selected for deletion. Specifically, snapshot module 150 uses nodeID 320 of the snapshot selected for deletion to determine the corresponding minVBA 350 from snapshot metadata table 154. Snapshot module 150 then searches for a count record 420 with both nodeID 320 and the determined minVBA 350 in count record map 156.

At step 904, if snapshot module 150 found such a count record 420, method 900 moves to step 906, and snapshot module 150 reads numAccessibleBlks 430 therein as a first number. However, if snapshot module 150 did not find such a count record 420 at step 904, list 410 of the snapshot selected for deletion must contain stale count records 420, and method 900 moves to step 908.

At step 908, snapshot module 150 determines the first number from multiple count records 420 of list 410 of the snapshot selected for deletion. Specifically, snapshot module 150 adds numAccessibleBlks 430 of each count record 420 that contains either the current minVBA 350 or a previous minVBA 350 of the segment of the snapshot selected for deletion.

At step 910, snapshot module 150 attempts to locate count record 420 storing the number of data blocks 160 owned by the snapshot selected for deletion that are shared with its child snapshot. Specifically, snapshot module 150 searches for a count record 420 with minVBA 350 of the segment of the snapshot selected for deletion and nodeID 320 of its child snapshot.

At step 912, if snapshot module 150 found such a count record 420, method 900 moves to step 914, and snapshot module 150 reads numAccessibleBlks 430 therein as a second number. If snapshot module 150 did not find such a count record 420 at step 912, list 410 of the child of the snapshot selected for deletion must contain stale count records 420, and method 900 moves to step 916.

At step 916, snapshot module 150 determines the second number from multiple count records 420 of list 410 of the child of the snapshot selected for deletion. Specifically, snapshot module 150 adds numAccessibleBlks 430 of each count record 420 that contains either the current minVBA 350 or a previous minVBA 350 of the segment of the snapshot selected for deletion. At step 918, snapshot module 150 subtracts the second number from the first number to determine the number of data blocks 160 that are exclusively accessible to the snapshot selected for deletion, i.e., the number of reclaimable data blocks 160. After step 918, method 900 ends.

FIG. 10 is a flow diagram of steps carried out by storage controller 142 to perform a method 1000 of deleting a selected snapshot and updating data structures, according to an embodiment. At step 1002, in snapshot logical map 152, snapshot module 150 deletes node 210 corresponding to the snapshot selected for deletion.

Turning to count record map 156, at step 1004, snapshot module 150 deletes list 410 of the snapshot selected for deletion by deleting each count record 420 with a nodeID 320 corresponding to the selected snapshot. Snapshot module 150 then begins merging count records 420 at the running point's list 410 according to the snapshot selected for deletion. At step 1006, snapshot module 150 selects count record 420 storing the number of data blocks 160 owned by the snapshot selected for deletion that are shared with the running point as a first count record 420. Specifically, snapshot module 150 selects count record 420 with the running point's nodeID 320 and a minVBA 350 of the segment of the snapshot selected for deletion. At step 1008, snapshot module 150 selects count record 420 storing the number of data blocks 160 owned by the child of the snapshot selected for deletion that are shared with the running point as a second count record 420. Specifically, snapshot module 150 selects count record 420 with the running point's nodeID 320 and a minVBA 350 of the segment of the child of the snapshot selected for deletion.

At step 1010, snapshot module 150 updates minVBA 350 of the second count record 420 (corresponding to the child's segment) to equal minVBA 350 of the first count record 420. At step 1012, snapshot module 150 increases numAccessibleBlks 430 of the second count record 420 (corresponding to the child's segment) by numAccessibleBlks 430 of the first count record 420. After step 1012, the second count record 420 (corresponding to the child's segment) is a merged count record 420 including data blocks 160 shared with the snapshot selected for deletion. At step 1014, snapshot module 150 deletes the first count record 420.

Turning to snapshot metadata table 154, at step 1016, snapshot module 150 updates parentNodeID 330 of entry 310 of the child of the snapshot selected for deletion. Snapshot module 150 stores nodeID 320 of the parent of the snapshot selected for deletion, which snapshot module 150 may determine by checking parentNodeID 330 of entry 310 of the snapshot selected for deletion. At step 1018, snapshot module 150 deletes entry 310 of the snapshot selected for deletion. At step 1020, storage controller 142 frees data blocks 160 that were exclusively accessible to the snapshot selected for deletion. After step 1020, the selected snapshot has been deleted, and method 1000 ends.

FIG. 11 is a flow diagram of steps carried out by storage controller 142 to perform a method 1100 of reverting to a selected snapshot and updating data structures, according to an embodiment. At step 1102, storage controller 142 detects an instruction from snapshot manager 172 to revert to the selected snapshot. An administrator may select the snapshot and instruct snapshot manager 172 to transmit the instruction. At step 1104, storage controller 142 frees all data blocks 160 in the running point's segment.

At step 1106, in snapshot logical map 152, snapshot module 150 deletes the running point's node 210 and creates a new running point node 210. Turning to snapshot metadata table 154, at step 1108, snapshot module 150 deletes the running point's entry 310 and creates a new running point entry 310. At step 1110, snapshot module 150 populates the fields of the new entry 310. Snapshot module 150 assigns a nodeID 320 to the new running point and stores it as the key of entry 310. Snapshot module 150 sets parentNodeID 330 to nodeID 320 of the snapshot that is being reverted to. Snapshot module 150 sets logicalMapRootAddr 340 to PBA 240 at which the root node 210 of snapshot logical map 152 is stored. Finally, snapshot module 150 sets minVBA 350 as the current value of nextVBA 158.

Turning to count record map 156, at step 1112, snapshot module 150 deletes the running point's list 410 by deleting each count record 420 with the previous running point's nodeID 320. At step 1114, snapshot module 150 makes copies of each count record 420 of list 410 of the snapshot being reverted to. For the copies, snapshot module 150 uses the new running point's nodeID 320. At step 1116, to the new running point's list 410, snapshot module 150 records a new count record 420, setting numAccessibleBlks 430 to 0. The key of the new count record 420 includes the new running point's nodeID 320 and minVBA 350.

At step 1118, snapshot module 150 merges count records 420 of the new running point's list 410 to reflect the current state of the snapshot chain. For example, one of count records 420 may correspond to a snapshot that was previously deleted, the shared data blocks 160 of which were inherited to its child. As such, snapshot module 150 merges count record 420 of the deleted snapshot with count record 420 of its former child snapshot. At the running point's list 410, snapshot module 150 updates minVBA 350 of count record 420 of the child to that of count record 420 of the deleted snapshot, updates numAccessibleBlks 430 of count record 420 of the child to the sum of numAccessibleBlks 430 of the two count records 420, and deletes count record 420 of the deleted snapshot. After step 1118, method 1100 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data that can thereafter be input into a computer system. Computer readable media may be based on any existing or subsequently developed technology that embodies computer programs in a manner that enables a computer to read the programs. Examples of computer readable media are HDDs, SSDs, network-attached storage (NAS) systems, read-only memory (ROM), RAM, compact disks (CDs), digital versatile disks (DVDs), magnetic tapes, and other optical and non-optical data storage devices. A computer readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of managing storage space of a storage device containing a plurality of snapshots of a file, comprising:
recording a first count record that includes a number of data blocks that are owned by a first snapshot;
after recording the first count record, recording a second count record that includes a number of data blocks that are both owned by the first snapshot and shared with a second snapshot that is a child snapshot of the first snapshot; and
determining an amount of reclaimable space of the first snapshot as the difference between the numbers of data blocks of the first and second count records.

2. The method of claim 1, wherein the data blocks that are owned by the first snapshot are data blocks that were allocated to the file after a parent snapshot of the first snapshot was created but before the first snapshot was created.

3. The method of claim 2, wherein the first and second count records each further include a minimum virtual block address (VBA) of the data blocks that are owned by the first snapshot.

4. The method of claim 3, further comprising:
based on the amount of reclaimable space of the first snapshot:
freeing data blocks that are both owned by the first snapshot and unshared with the second snapshot;
selecting a third count record that includes a number of data blocks that are both owned by the first snapshot and shared with a running point;
selecting a fourth count record that includes a number of data blocks that are both owned by the second snapshot and shared with the running point; and
increasing the number of data blocks of the fourth count record by the number of data blocks of the third count record.

5. The method of claim 4, further comprising:
updating the fourth count record to include a minimum VBA of data blocks included by the third count record; and
deleting the third count record.

6. The method of claim 3, further comprising:
detecting a write input/output operation (IO) including a write address of a data block to write to;
determining that the write address corresponds to a data block that is owned by a third snapshot; and
in response to the determination that the write address corresponds to the data block of the third snapshot:
allocating a new data block to the file;
writing to the newly allocated data block;
incrementing a number of data blocks of a third count record, the number of data blocks of the third count record indicating a number of data blocks owned by a running point; and
decrementing a number of data blocks of a fourth count record, the number of data blocks of the fourth count record indicating a number of data blocks that are both owned by the third snapshot and shared with the running point.

7. The method of claim 2, wherein the file is a virtual disk of a virtual machine.

8. A non-transitory computer readable medium comprising instructions that are executable in a computer system, wherein the instructions when executed cause the computer system to carry out a method of managing storage space of a storage device containing a plurality of snapshots of a file, said method comprising:
recording a first count record that includes a number of data blocks that are owned by a first snapshot;
after recording the first count record, recording a second count record that includes a number of data blocks that are both owned by the first snapshot and shared with a second snapshot that is a child snapshot of the first snapshot; and
determining an amount of reclaimable space of the first snapshot as the difference between the numbers of data blocks of the first and second count records.

9. The non-transitory computer readable medium of claim 8, wherein the data blocks that are owned by the first snapshot are data blocks that were allocated to the file after a parent snapshot of the first snapshot was created but before the first snapshot was created.

10. The non-transitory computer readable medium of claim 9, wherein the first and second count records each further include a minimum virtual block address (VBA) of the data blocks that are owned by the first snapshot.

11. The non-transitory computer readable medium of claim 10, the method further comprising:
based on the amount of reclaimable space of the first snapshot:
freeing data blocks that are both owned by the first snapshot and unshared with the second snapshot;
selecting a third count record that includes a number of data blocks that are both owned by the first snapshot and shared with a running point;
selecting a fourth count record that includes a number of data blocks that are both owned by the second snapshot and shared with the running point; and
increasing the number of data blocks of the fourth count record by the number of data blocks of the third count record.

12. The non-transitory computer readable medium of claim 11, the method further comprising:
updating the fourth count record to include a minimum VBA of data blocks included by the third count record; and
deleting the third count record.

13. The non-transitory computer readable medium of claim 10, the method further comprising:
detecting a write input/output operation (IO) including a write address of a data block to write to;
determining that the write address corresponds to a data block that is owned by a third snapshot; and
in response to the determination that the write address corresponds to the data block of the third snapshot:
allocating a new data block to the file;
writing to the newly allocated data block;
incrementing a number of data blocks of a third count record, the number of data blocks of the third count record indicating a number of data blocks owned by a running point; and
decrementing a number of data blocks of a fourth count record, the number of data blocks of the fourth count record indicating a number of data blocks that are both owned by the third snapshot and shared with the running point.

14. The non-transitory computer readable medium of claim 9, wherein the file is a virtual disk of a virtual machine.

15. A computer system comprising:
a plurality of hosts in a cluster; and
a storage device containing a plurality of snapshots of a file, wherein the storage device executes instructions to manage storage space, and the instructions cause the storage device to carry out a method comprising:
recording a first count record that includes a number of data blocks that are owned by a first snapshot,
after recording the first count record, recording a second count record that includes a number of data blocks that are both owned by the first snapshot and shared with a second snapshot that is a child snapshot of the first snapshot, and
determining an amount of reclaimable space of the first snapshot as the difference between the numbers of data blocks of the first and second count records.

16. The computer system of claim 15, wherein the data blocks that are owned by the first snapshot are data blocks that were allocated to the file after a parent snapshot of the first snapshot was created but before the first snapshot was created.

17. The computer system of claim 16, wherein the first and second count records each further include a minimum virtual block address (VBA) of the data blocks that are owned by the first snapshot.

18. The computer system of claim 17, the method further comprising:
based on the amount of reclaimable space of the first snapshot:
freeing data blocks that are both owned by the first snapshot and unshared with the second snapshot,
selecting a third count record that includes a number of data blocks that are both owned by the first snapshot and shared with a running point,
selecting a fourth count record that includes a number of data blocks that are both owned by the second snapshot and shared with the running point, and
increasing the number of data blocks of the fourth count record by the number of data blocks of the third count record.

19. The computer system of claim 18, the method further comprising:
updating the fourth count record to include a minimum VBA of data blocks included by the third count record, and
deleting the third count record.

20. The computer system of claim 17, the method further comprising:
detecting a write input/output operation (IO) including a write address of the storage device to write to,
determining that the write address corresponds to a data block that is owned by a third snapshot, and
in response to the determination that the write address corresponds to the data block of the third snapshot:
allocating a new data block to the file,
writing to the newly allocated data block,
incrementing a number of data blocks of a third count record, the number of data blocks of the third count record indicating a number of data blocks owned by a running point, and
decrementing a number of data blocks of a fourth count record, the number of data blocks of the fourth count record indicating a number of data blocks that are both owned by the third snapshot and shared with the running point.
